(19) United States
(12) Patent Application Publication
(10) Pub. No.: US 2025/0077072 A1
(43) Pub. Date: Mar. 6, 2025

(54) MOBILE TERMINAL

(71) Applicant: KAWASAKI JUKOGYO KABUSHIKI KAISHA, Kobe-shi (JP)

(72) Inventors: Akihiro KONDO, Kobe-shi (JP); Yousuke KATAOKA, Kobe-shi (JP); Jun UMEKAWA, Kobe-shi (JP)

(73) Assignee: KAWASAKI JUKOGYO KABUSHIKI KAISHA, Kobe-shi (JP)

(21) Appl. No.: 18/774,033

(22) Filed: Jul. 16, 2024

(30) Foreign Application Priority Data
Aug. 30, 2023 (JP) 2023-139868

(51) Int. Cl. G06F 3/04886; F04B 49/06; G06F 3/0484; G06K 19/06; G06K 19/07

(52) U.S. Cl. CPC G06F 3/04886; G06F 3/0484; G06K 19/06037; G06K 19/0723; F04B 49/065

(57) ABSTRACT

A processor of a mobile terminal according to one embodiment obtains and stores actual measurement data of a hydraulic pump in a memory when a camera has captured an image of a symbol displayed on a surface of the hydraulic pump. The processor also stores, in the memory, a minimum-use delivery flow rate and a reference rotation speed that have been inputted with an input screen on a touchscreen. Further, the processor causes a wireless communicator to transmit the actual measurement data, the minimum-use delivery flow rate, and the reference rotation speed, which are stored in the memory, to control circuitry for the hydraulic pump or to a wireless LAN router connected to the control circuitry when a data transmission button on the touchscreen is tap-operated.

### CROSS-REFERENCE TO RELATED APPLICATION

This application claims priority to and the benefit of Japanese Patent Application No. 2023-139868, filed on Aug. 23, 2023, the entire disclosure of which is incorporated herein by reference.

### BACKGROUND OF THE INVENTION

### Field of the Invention

The present disclosure relates to a mobile terminal that is communicable with control circuitry for a hydraulic pump via wireless communication.

### Description of the Related Art

In machines such as construction machines or industrial machines, there is a case where a hydraulic pump whose displacement, i.e., a delivery amount per rotation of the hydraulic pump, increases in accordance with increase in a command current is adopted as a hydraulic pump to supply a hydraulic liquid to a hydraulic actuator. See, for example, Japanese Laid-Open Patent Application Publication No. 2019-210974. In this case, the hydraulic pump is controlled by control circuitry, such that the displacement of the hydraulic pump increases in accordance with increase in the moving speed of the hydraulic actuator.

Specifically, an operation signal corresponding to an operating amount of an operator to move the hydraulic actuator is inputted to the control circuitry. The operator is a device to determine the moving speed of the hydraulic actuator by the operating amount of the operator. The control circuitry feeds a command current corresponding to the operation signal to the hydraulic pump.

### SUMMARY OF THE INVENTION

Incidentally, a required minimum displacement of a hydraulic pump differs depending on what machine the hydraulic pump is installed in. In the case of a hydraulic pump whose displacement increases in accordance with increase in a command current, a minimum-use displacement of the hydraulic pump, which is greater than or equal to the mechanical minimum displacement of the hydraulic pump, can be electrically set. By setting the minimum-use displacement of the hydraulic pump in this manner, the same hydraulic pump is usable in different machines that require different minimum pump displacements, respectively.

However, hydraulic pumps, due to their individual differences, vary from each other in terms of I-q characteristics. The I-q characteristics are a relationship between the command current and the displacement. Accordingly, in a case where a minimum-use electric current corresponding to the minimum-use displacement is determined based on design performance characteristics, there is a possibility that the minimum-use displacement deviates from a value to which the minimum-use displacement is to be set.

There is a case where not the minimum displacement, but the minimum delivery flow rate at a reference rotation speed is required from a hydraulic pump. In this case, similar to the above, a minimum-use delivery flow rate at the reference rotation speed can be set electrically. However, in a case where a minimum-use electric current corresponding to the minimum-use delivery flow rate is determined based on design performance characteristics, there is a possibility that, for the same reason as mentioned above, the minimum-use delivery flow rate deviates from a value to which the minimum-use delivery flow rate is to be set.

In view of the above, an object of the present disclosure is to provide a mobile terminal that makes it possible to precisely set, with control circuitry, the minimum-use displacement of a hydraulic pump, or the minimum-use delivery flow rate of the hydraulic pump at a reference rotation speed.

A first aspect of the present disclosure provides a mobile terminal including a processor, a memory, a wireless communicator, a touchscreen, and a camera. The processor: obtains and stores actual measurement data in the memory when the camera has captured an image of a symbol displayed on a surface of a hydraulic pump whose displacement increases in accordance with increase in a command current, the actual measurement data indicating an actual relationship between the command current and the displacement of the hydraulic pump or indicating a predetermined rotation speed and an actual relationship between the command current and a delivery flow rate of the hydraulic pump at the predetermined rotation speed; displays, on the touchscreen, an input screen to input a minimum-use delivery flow rate of the hydraulic pump and a reference rotation speed of the hydraulic pump, the reference rotation speed being a rotation speed to define the minimum-use delivery flow rate, and stores, in the memory, the minimum-use delivery flow rate and the reference rotation speed that have been inputted with the input screen; and displays a virtual data transmission button on the touchscreen, and when the data transmission button is tap-operated, causes the wireless communicator to transmit the actual measurement data, the minimum-use delivery flow rate, and the reference rotation speed, which are stored in the memory, to control circuitry for the hydraulic pump or to a wireless LAN router connected to the control circuitry.

A second aspect of the present disclosure provides a mobile terminal including a processor, a memory, a wireless communicator, a touchscreen, and a camera. The processor: obtains and stores actual measurement data in the memory when the camera has captured an image of a symbol displayed on a surface of a hydraulic pump whose displacement increases in accordance with increase in a command current, the actual measurement data indicating an actual relationship between the command current and the displacement of the hydraulic pump or indicating a predetermined rotation speed and an actual relationship between the command current and a delivery flow rate of the hydraulic pump at the predetermined rotation speed; displays, on the touchscreen, an input screen to input a minimum-use displacement of the hydraulic pump, and stores, in the memory, the minimum-use displacement that has been inputted with the input screen; and displays a virtual data transmission button on the touchscreen, and when the data transmission button is tap-operated, causes the wireless communicator to transmit the actual measurement data and the minimum-use displacement, which are stored in the memory, to control circuitry for the hydraulic pump or to a wireless LAN router connected to the control circuitry.

A third aspect of the present disclosure provides a mobile terminal including a processor, a memory, a wireless communicator, a touchscreen, and a camera. The processor: obtains and stores actual measurement data in the memory when the camera has captured an image of a symbol displayed on a surface of a hydraulic pump whose displacement increases in accordance with increase in a command current, the actual measurement data indicating an actual relationship between the command current and the displacement of the hydraulic pump or indicating a predetermined rotation speed and an actual relationship between the command current and a delivery flow rate of the hydraulic pump at the predetermined rotation speed; displays, on the touchscreen, an input screen to input a minimum-use delivery flow rate of the hydraulic pump and a reference rotation speed of the hydraulic pump, the reference rotation speed being a rotation speed to define the minimum-use delivery flow rate, stores, in the memory, the minimum-use delivery flow rate and the reference rotation speed that have been inputted with the input screen, determines a minimum-use electric current corresponding to the inputted minimum-use delivery flow rate by using the actual measurement data, and stores the determined minimum-use electric current in the memory; and displays a virtual data transmission button on the touchscreen, and when the data transmission button is tap-operated, causes the wireless communicator to transmit the actual measurement data and the minimum-use electric current, which are stored in the memory, to control circuitry for the hydraulic pump or to a wireless LAN router connected to the control circuitry.

A fourth aspect of the present disclosure provides a mobile terminal including a processor, a memory, a wireless communicator, a touchscreen, and a camera. The processor: obtains and stores actual measurement data in the memory when the camera has captured an image of a symbol displayed on a surface of a hydraulic pump whose displacement increases in accordance with increase in a command current, the actual measurement data indicating an actual relationship between the command current and the displacement of the hydraulic pump or indicating a predetermined rotation speed and an actual relationship between the command current and a delivery flow rate of the hydraulic pump at the predetermined rotation speed; displays, on the touchscreen, an input screen to input a minimum-use displacement of the hydraulic pump, stores, in the memory, the minimum-use displacement that has been inputted with the input screen, determines a minimum-use electric current corresponding to the inputted minimum-use displacement by using the actual measurement data, and stores the determined minimum-use electric current in the memory; and displays a virtual data transmission button on the touchscreen, and when the data transmission button is tap-operated, causes the wireless communicator to transmit the actual measurement data and the minimum-use electric current, which are stored in the memory, to control circuitry for the hydraulic pump or to a wireless LAN router connected to the control circuitry.

The present disclosure provides a mobile terminal that makes it possible to precisely set, with control circuitry, the minimum-use displacement of a hydraulic pump, or the minimum-use delivery flow rate of the hydraulic pump at a reference rotation speed.

### BRIEF DESCRIPTION OF THE DRAWINGS

FIG. 1 shows a schematic configuration of a pump system including a mobile terminal according to Embodiment 1.

FIGS. 2A to 2D each show a display screen on a touchscreen of the mobile terminal.

FIG. 3 is a graph showing a relationship between a command current and a displacement of a hydraulic pump.

FIG. 4 shows the display screen on the touchscreen of a first variation of the mobile terminal.

FIG. 5 shows a schematic configuration of the pump system including a second variation of the mobile terminal.

FIGS. 6A to 6D each show the display screen on the touchscreen of a third variation of the mobile terminal.

FIGS. 7A to 7C each show the display screen on the touchscreen of a fourth variation of the mobile terminal.

FIGS. 8A and 8B each show the display screen on the touchscreen of a mobile terminal according to Embodiment 2.

### DETAILED DESCRIPTION

### Embodiment 1

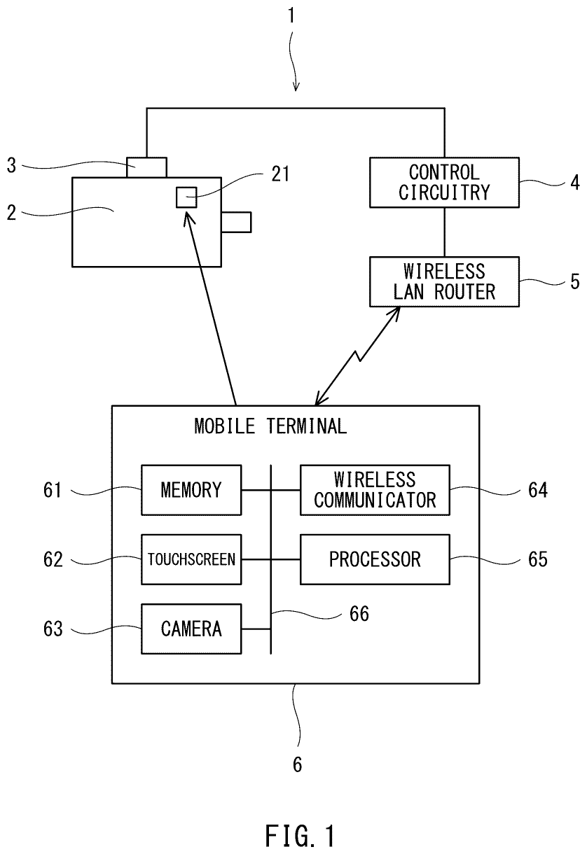

FIG. 1 shows a pump system 1 including a mobile terminal 6 according to Embodiment 1. A program is installed on the mobile terminal 6.

The pump system 1 includes, in addition to the mobile terminal 6, a hydraulic pump 2 and control circuitry 4 for the hydraulic pump 2. The mobile terminal 6 is communicable with the control circuitry 4 via wireless communication.

In the present embodiment, a wireless LAN router 5 is wire-connected to the control circuitry 4, and the mobile terminal 6 performs wireless communication with the wireless LAN router 5. Alternatively, the control circuitry 4 may include a wireless communicator, and the mobile terminal 6 may directly perform wireless communication with the control circuitry 4.

The hydraulic pump 2 is a variable displacement pump. The hydraulic pump 2 is driven by a prime mover. The prime mover may be an engine, or may be an electric motor. In the present embodiment, the hydraulic pump 2 is an axial piston pump, such as a swash plate pump or a bent axis pump. Alternatively, the hydraulic pump 2 may be a different type of pump, such as a vane pump.

A displacement q of the hydraulic pump 2, which is a delivery amount per rotation of the hydraulic pump 2, is changed by a regulator 3 installed on the hydraulic pump 2. The regulator 3 is fed with a command current I from the control circuitry 4. For example, in a case where the hydraulic pump 2 is a swash plate pump, the regulator 3 may electrically change a hydraulic pressure applied to a servo piston coupled to the swash plate of the hydraulic pump 2, or may be an electric actuator coupled to the swash plate of the hydraulic pump 2.

The hydraulic pump 2 supplies a hydraulic liquid to a hydraulic actuator. The control circuitry 4 receives an input of an actuator operation signal corresponding to an operating amount of an operator that is a device to move the hydraulic actuator. The control circuitry 4 outputs the command current I corresponding to the actuator operation signal to the regulator 3, such that the displacement q of the hydraulic pump 2 increases in accordance with increase in the operating amount of the operator. In a case where the hydraulic pump 2 and the hydraulic actuator are installed in an unmanned machine, the operator may be eliminated, and the control circuitry 4 may generate the actuator operation signal based on, for example, an image captured by a camera.

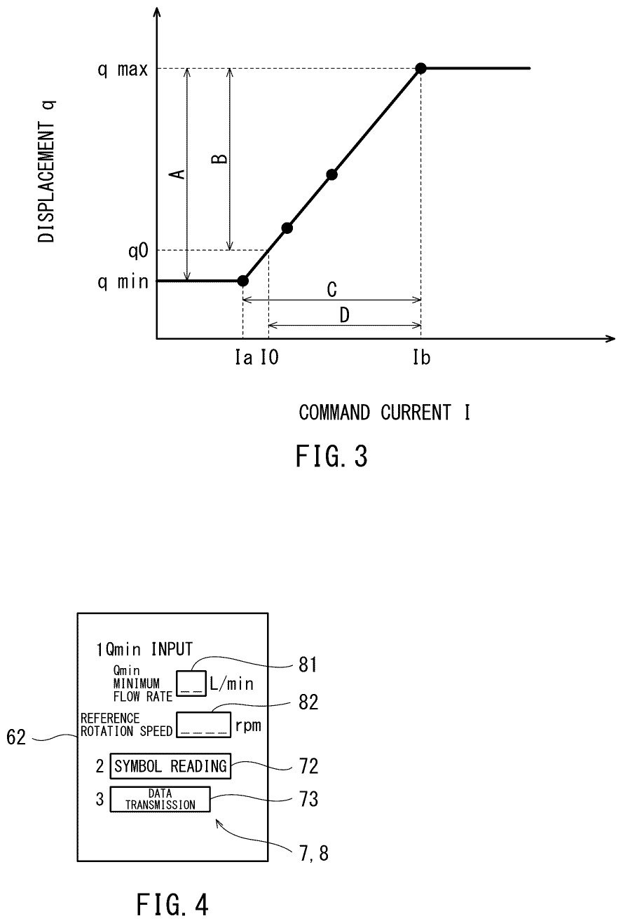

The displacement q of the hydraulic pump 2 changes between a mechanical minimum displacement qmin and a mechanical maximum displacement qmax in accordance with the command current I. FIG. 3 shows I-q characteristics, i.e., a relationship between the command current I and the displacement q. When the command current I is less than or equal to Ia, the displacement q is the minimum displacement qmin. When the command current I is greater than or equal to Ib, the displacement q is the maximum displacement qmax. When the command current I is between Ia and Ib, the displacement q increases in accordance with increase in the command current I.

Returning to FIG. 1, a symbol 21 is displayed on the surface of the hydraulic pump 2. For the display of the symbol 21 on the surface of the hydraulic pump 2, the symbol 21 may be printed on a plate, such as a nameplate or a display plate, and the plate may be mounted to the surface of the hydraulic pump 2. Alternatively, the symbol 21 may be directly printed on the surface of the hydraulic pump 2.

In the present embodiment, the symbol 21 stores actual measurement data that indicates actual I-q characteristics of the hydraulic pump 2. The actual I-q characteristics are test results obtained from a performance validation test conducted on the hydraulic pump 2. For example, the symbol 21 is a matrix two-dimensional code (QR code (registered trademark)). Alternatively, the symbol 21 may be a tag, such as an IC (Integrated Circuit) tag or an RFID (Radio Frequency Identification) tag.

The mobile terminal 6 includes a memory 61, a touchscreen 62, a camera 63, a wireless communicator 64, and a processor 65. These elements are connected to each other by a bus 66. The mobile terminal 6 is, for example, a tablet terminal or a smartphone.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

The processor 65 of the mobile terminal 6 performs operations described below in accordance with the program stored in the memory 61. As a result of the processor 65 performing the operations, a data processing method using the mobile terminal 6 is performed.

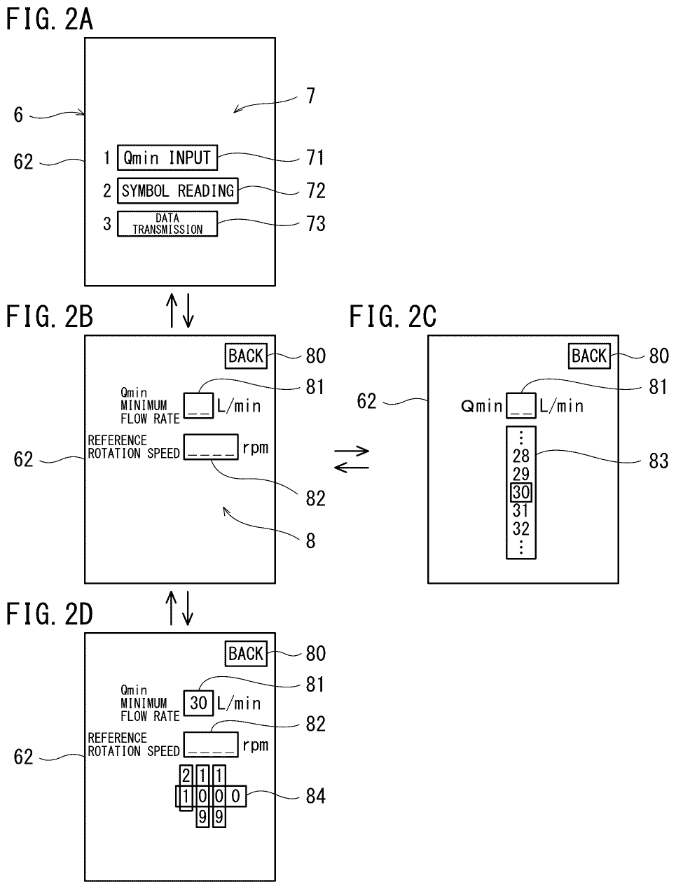

When a program icon that represents the program and that is displayed on the touchscreen 62 is tap-operated by a user, the processor 65 displays an initial screen 7 as shown in FIG. 2A on the touchscreen 62. All of the tap operations described below are performed by the user. The initial screen 7 includes a Qmin input button 71, a symbol reading button 72, and a data transmission button 73, which are virtual buttons.

The Qmin input button 71 is a button to display an input screen 8 as shown in FIG. 2B. The input screen 8 is a screen to input a minimum-use delivery flow rate Qmin and a reference rotation speed Nr. The reference rotation speed Nr is a rotation speed to define the minimum-use delivery flow rate Qmin.

As shown in FIG. 3, a minimum-use displacement q0, which is obtained by dividing the minimum-use delivery flow rate Qmin by the reference rotation speed Nr, defines the lower limit of the range of use of the displacement q when the hydraulic pump 2 is installed in a machine. The minimum-use displacement q0 may be the same as the mechanical minimum displacement qmin, or may be greater than the minimum displacement qmin.

In a case where the minimum-use displacement q0 is the same as the mechanical minimum displacement qmin, when the hydraulic pump 2 is installed in a machine, the range of use of the displacement q is a range A shown in FIG. 3, and the range of use of the command current I is a range C shown in FIG. 3. On the other hand, in a case where the minimum-use displacement q0 is greater than the mechanical minimum displacement qmin, when the hydraulic pump 2 is installed in a machine, the range of use of the displacement q is a range B shown in FIG. 3, and the range of use of the command current I is a range D shown in FIG. 3.

When the Qmin input button 71 in the initial screen 7 is tap-operated, the processor 65 displays the input screen 8 on the touchscreen 62. The input screen 8 includes: a first input frame 81 to input the minimum-use delivery flow rate Qmin; and a second input frame 82 to input the reference rotation speed Nr. In the present embodiment, each of the first input frame 81 and the second input frame 82 is of a pull-down type frame, i.e., a frame to select one of predetermined options. The pull-down input frame may be of a type to select a set of multiple digits of a numerical value, or may be of a type to select each digit of the numerical value.

When the first input frame 81 in the input screen 8 is tap-operated, as shown in FIG. 2C, the processor 65 displays, below the first input frame 81, a selection frame 83, in which numerical values are listed each as a delivery flow rate. When a particular numerical value in the selection frame 83 is selected, the processor 65 displays the selected numerical value in the first input frame 81, and stores the selected numerical value in the memory 61 as an inputted minimum-use delivery flow rate Qmin. Thereafter, when a virtual back button 80 is tap-operated, the processor 65 brings the display screen on the touchscreen 62 back to the input screen 8 shown in FIG. 2B.

When the second input frame 82 in the input screen 8 is tap-operated, as shown in FIG. 2D, the processor 65 displays, below the second input frame 82, a selection frame 84, in which, for each digit of a rotation speed value, a single numerical value or a list of numerical values is/are displayed. Alternatively, the selection frame 84 may display a list of three-digit or four-digit numerical values as rotation speed values. When a combination of particular numerical values is selected in the selection frame 84, the processor 65 displays the selected numerical value combination in the second input frame 82, and stores the selected numerical value combination in the memory 61 as an inputted reference rotation speed Nr. Thereafter, when the virtual back button 80 is tap-operated, the processor 65 brings the display screen on the touchscreen 62 back to the input screen 8 shown in FIG. 2B.

When the virtual back button 80 in the input screen 8 is tap-operated, the processor 65 brings the display screen on the touchscreen 62 back to the initial screen 7 shown in FIG. 2A.

The symbol reading button 72 is a button to start reading the symbol 21 displayed on the surface of the hydraulic pump 2. When the symbol reading button 72 is tap-operated, the processor 65 starts the camera 63.

When the camera 63 focuses on the symbol 21, the camera 63 automatically captures an image of the symbol 21. When the camera 63 has captured an image of the symbol 21, the processor 65 obtains the actual measurement data of the hydraulic pump 2, which is stored in the symbol 21, and stores the obtained actual measurement data in the memory 61. That is, reading the symbol 21 means obtaining characteristic data stored in the symbol 21 by capturing an image of the symbol 21. As one example of the order of operations, the inputting of the minimum-use delivery flow rate Qmin and the reference rotation speed Nr may be performed after reading the symbol 21.

The data transmission button 73 is a button to transmit the actual measurement data of the hydraulic pump 2, the minimum-use delivery flow rate Qmin of the hydraulic pump 2, and the reference rotation speed Nr of the hydraulic pump 2, which are stored in the memory 61, to the wireless LAN router 5. After the reading of the symbol 21 is completed, when the data transmission button 73 is tap-operated, the processor 65 causes the wireless communicator 64 to transmit the actual measurement data of the hydraulic pump 2, the minimum-use delivery flow rate Qmin of the hydraulic pump 2, and the reference rotation speed Nr of the hydraulic pump 2, which are stored in the memory 61, to the wireless LAN router 5. Accordingly, the actual measurement data of the hydraulic pump 2, the minimum-use delivery flow rate Qmin of the hydraulic pump 2, and the reference rotation speed Nr of the hydraulic pump 2 are inputted to the control circuitry 4 via the wireless LAN router 5.

The control circuitry 4 electronically calibrates variation in the I-q characteristics of the hydraulic pump 2 due to its individual differences. Specifically, the control circuitry 4 uses the actual measurement data inputted thereto to adjust the command current I outputted to the regulator 3, such that a preset displacement corresponding to the actuator operation signal is obtained.

Further, in the present embodiment, by using the inputted actual measurement data, the control circuitry 4 determines a minimum-use electric current 10 corresponding to the minimum-use delivery flow rate Qmin by use of a mathematical technique, such as linear interpolation. In the present embodiment, since the actual measurement data are I-q characteristics, the control circuitry 4 calculates the minimum-use displacement q0 by dividing the minimum-use delivery flow rate Qmin by the reference rotation speed Nr, and determines the minimum-use electric current 10 corresponding to the minimum-use displacement q0 by using the actual measurement data indicating the actual I-q characteristics.

As described above, in the present embodiment, the control circuitry 4 can determine the minimum-use electric current 10 corresponding to the minimum-use delivery flow rate Qmin by using the actual measurement data. Therefore, with the control circuitry 4, the minimum-use delivery flow rate Qmin of the hydraulic pump 2 at the reference rotation speed Nr can be set precisely.

### <Variations>

As shown in FIG. 4, in the initial screen 7, “Qmin INPUT” may be displayed instead of the Qmin input button 71. Also, the first input frame 81 and the second input frame 82 may be adopted, and the initial screen 7 may double as the input screen 8.

In a case where the control circuitry 4 includes a wireless communicator, the processor 65 may cause the wireless communicator 64 to transmit the actual measurement data of the hydraulic pump 2, the minimum-use delivery flow rate Qmin of the hydraulic pump 2, and the reference rotation speed Nr of the hydraulic pump 2, which are stored in the memory 61, to the control circuitry 4.

Instead of storing the actual measurement data of the hydraulic pump 2, the symbol 21 may store save location information on the actual measurement data. The save location information is, for example, the IP (Internet Protocol) address of a server that is the save location, or the URL (Uniform Resource Locator) of a particular hierarchy level of the server. The symbol 21 storing the save location information may be a two-dimensional code or a tag as with the above-described embodiment, or may be a character string.

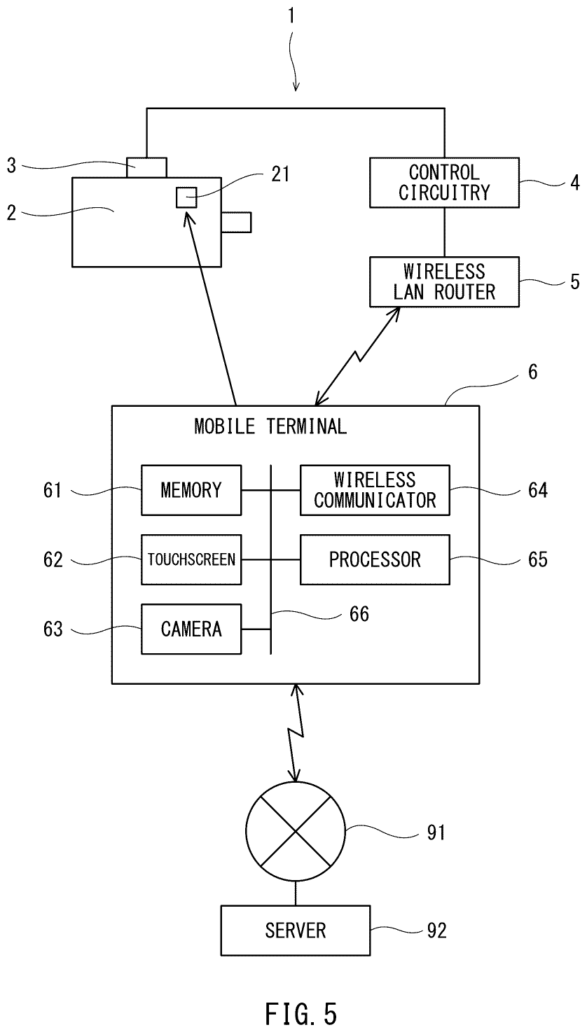

In a case where the symbol 21 stores the save location information, as shown in FIG. 5, when the camera 63 has captured an image of the symbol 21, the processor 65 of the mobile terminal 6 obtains the actual measurement data of the hydraulic pump 2 via a network 91 from a server 92 specified by the save location information stored in the symbol 21. Processes performed thereafter are the same as those described in the above embodiment.

Also in the case where the symbol 21 stores the save location information on the characteristic data, the control circuitry 4 may include a wireless communicator, and the processor 65 may cause the wireless communicator 64 to transmit the actual measurement data of the hydraulic pump 2, the minimum-use delivery flow rate Qmin of the hydraulic pump 2, and the reference rotation speed Nr of the hydraulic pump 2 to the control circuitry 4.

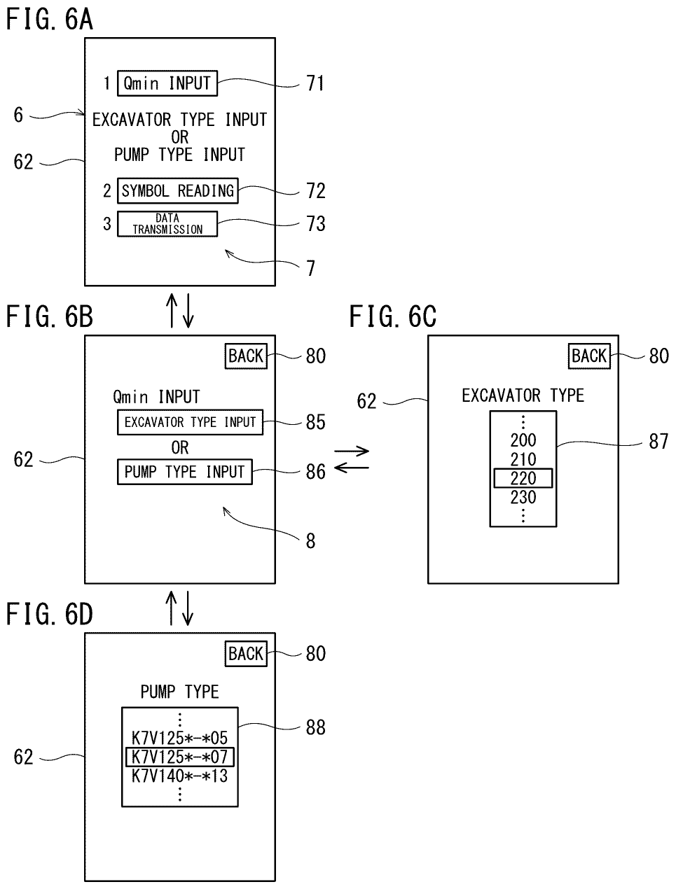

Various variations of the input screen 8 to input the minimum-use delivery flow rate Qmin and the reference rotation speed Nr are adoptable. As one variation, in a case where the hydraulic pump 2 is installed in a hydraulic excavator, as shown in FIG. 6A, the initial screen 7 may display, for the Qmin input button 71, an explanation “EXCAVATOR TYPE INPUT OR PUMP TYPE INPUT”. When the Qmin input button 71 is tap-operated, the processor 65 displays the input screen 8 shown in FIG. 6B on the touchscreen 62.

In this variation, the input screen 8 includes an excavator type input frame 85 and a pump type input frame 86. Each of the excavator type input frame 85 and the pump type input frame 86 is a button to input the minimum-use delivery flow rate Qmin and the reference rotation speed Nr. Each of the excavator type input frame 85 and the pump type input frame 86 is of a pull-down type frame.

When the excavator type input frame 85 in the input screen 8 is tap-operated, as shown in FIG. 6C, the processor 65 displays, on the touchscreen 62, a selection frame 87, in which multiple excavator types are listed. In the memory 61, information on the minimum-use delivery flow rate Qmin and the reference rotation speed Nr is stored in association with each excavator type. When a particular excavator type in the selection frame 87 is selected, the processor 65 stores, in the memory 61, the minimum-use delivery flow rate Qmin and the reference rotation speed Nr that correspond to the selected excavator type as an inputted minimum-use delivery flow rate Qmin and an inputted reference rotation speed Nr. Thereafter, when the virtual back button 80 is tap-operated, the processor 65 brings the display screen on the touchscreen 62 back to the input screen 8 shown in FIG. 6B.

Alternatively, when the pump type input frame 86 in the input screen 8 is tap-operated, as shown in FIG. 6D, the processor 65 displays, on the touchscreen 62, a selection frame 88, in which multiple pump types are listed. In the memory 61, information on the minimum-use delivery flow rate Qmin and the reference rotation speed Nr is stored in association with each pump type. When a particular pump type in the selection frame 88 is selected, the processor 65 stores, in the memory 61, the minimum-use delivery flow rate Qmin and the reference rotation speed Nr that correspond to the selected pump type as an inputted minimum-use delivery flow rate Qmin and an inputted reference rotation speed Nr. Thereafter, when the virtual back button 80 is tap-operated, the processor 65 brings the display screen on the touchscreen 62 back to the input screen 8 shown in FIG. 6B.

When the virtual back button 80 in the input screen 8 is tap-operated, the processor 65 brings the display screen on the touchscreen 62 back to the initial screen 7 shown in FIG. 6A.

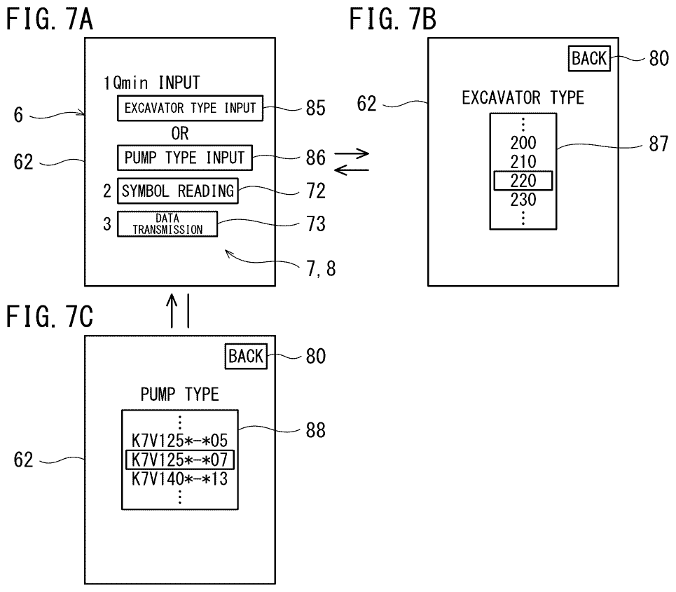

Alternatively, as shown in FIGS. 7A to 7C, in the initial screen 7, “Qmin INPUT” may be displayed instead of the Qmin input button 71. Also, the excavator type input frame 85 and the pump type input frame 86 may be adopted, and the initial screen 7 may double as the input screen 8.

### Embodiment 2

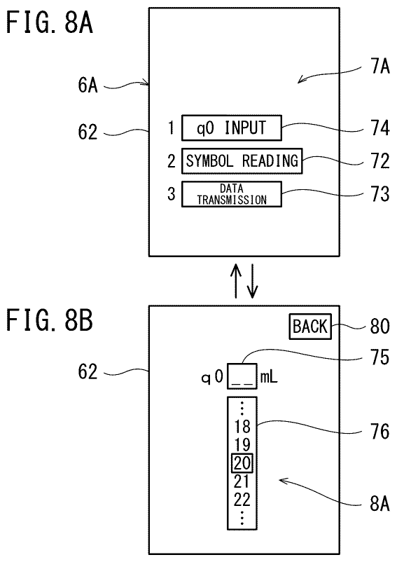

Next, with reference to FIGS. 8A and 8B, a mobile terminal 6A according to Embodiment 2 is described. The mobile terminal 6A of the present embodiment is different from the mobile terminal 6 of Embodiment 1 only in that the minimum-use displacement q0 is inputted instead of the minimum-use delivery flow rate Qmin and the reference rotation speed Nr. In the present embodiment, the same components as those described in Embodiment 1 are denoted by the same reference signs as those used in Embodiment 1, and repeating the same descriptions is avoided.

In the present embodiment, when the program icon displayed on the touchscreen 62 is tap-operated, the processor 65 of the mobile terminal 6A displays an initial screen 7A as shown in FIG. 8A on the touchscreen 62. The initial screen 7A includes a q0 input button 74, the symbol reading button 72, and the data transmission button 73, which are virtual buttons.

The q0 input button 74 is a button to display an input screen 8A as shown in FIG. 8B. The input screen 8A is a screen to input the minimum-use displacement q0. When the q0 input button 74 in the initial screen 7 is tap-operated, the processor 65 displays the input screen 8A on the touchscreen 62.

The input screen 8A includes an input frame 75 to input the minimum-use displacement q0. In the present embodiment, the input frame 75 is a pull-down type frame, i.e., a frame to select one of predetermined options. The pull-down input frame may be of a type to select a set of multiple digits of a numerical value, or may be of a type to select each digit of the numerical value.

When the input frame 75 in the input screen 8A is tap-operated, the processor 65 displays, below the input frame 75, a selection frame 76, in which numerical values are listed each as a displacement of the hydraulic pump 2. When a particular numerical value in the selection frame 76 is selected, the processor 65 displays the selected numerical value in the input frame 75, and stores the selected numerical value in the memory 61 as an inputted minimum-use displacement q0. Thereafter, when the virtual back button 80 is tap-operated, the processor 65 brings the display screen on the touchscreen 62 back to the initial screen 7A shown in FIG. 8A.

Similar to Embodiment 1, the symbol 21 storing the actual measurement data indicating the actual I-q characteristics of the hydraulic pump 2 is displayed on the surface of the hydraulic pump 2. The symbol 21 is a two-dimensional code or a tag.

When the symbol reading button 72 in the initial screen 7A is tap-operated, the processor 65 starts the camera 63. When the camera 63 focuses on the symbol 21, the camera 63 automatically captures an image of the symbol 21. When the camera 63 has captured an image of the symbol 21, the processor 65 obtains the actual measurement data of the hydraulic pump 2, which is stored in the symbol 21, and stores the obtained actual measurement data in the memory 61.

When the data transmission button 73 in the initial screen 7A is tap-operated, the processor 65 causes the wireless communicator 64 to transmit the actual measurement data of the hydraulic pump 2 and the minimum-use displacement q0 of the hydraulic pump 2, which are stored in the memory 61, to the wireless LAN router 5.

In the present embodiment, the control circuitry 4 can determine the minimum-use electric current 10 corresponding to the minimum-use displacement q0 by using the actual measurement data indicating the actual I-q characteristics. Therefore, with the control circuitry 4, the minimum-use displacement q0 of the hydraulic pump 2 can be set precisely.

### <Variations>

In a case where the control circuitry 4 includes a wireless communicator, the processor 65 may cause the wireless communicator 64 to transmit the actual measurement data of the hydraulic pump 2 and the minimum-use displacement q0 of the hydraulic pump 2, which are stored in the memory 61, to the control circuitry 4.

Instead of storing the actual measurement data of the hydraulic pump 2, the symbol 21 may store save location information on the actual measurement data. The save location information is, for example, the IP address of a server that is the save location, or the URL of a particular hierarchy level of the server. The symbol 21 storing the save location information may be a two-dimensional code or a tag, or may be a character string.

In a case where the symbol 21 stores the save location information, as shown in FIG. 5, when the camera 63 has captured an image of the symbol 21, the processor 65 of the mobile terminal 6A obtains the actual measurement data of the hydraulic pump 2 via the network 91 from the server 92 specified by the save location information stored in the symbol 21.

Also in the case where the symbol 21 stores the save location information on the characteristic data, the control circuitry 4 may include a wireless communicator, and the processor 65 may cause the wireless communicator 64 to transmit the actual measurement data of the hydraulic pump 2 and the minimum-use displacement q0 of the hydraulic pump 2 to the control circuitry 4.

### Other Embodiments

The present disclosure is not limited to the above-described embodiments. Various modifications can be made without departing from the scope of the present disclosure.

For example, the actual measurement data need not be one indicating the actual I-q characteristics, but may be one indicating a predetermined rotation speed Np and an actual relationship between the command current I and the delivery flow rate Q of the hydraulic pump 2 at the predetermined rotation speed Np, i.e., actual I-Q characteristics at the predetermined rotation speed Np.

In Embodiment 1, in a case where the actual measurement data is one indicating the predetermined rotation speed Np and the actual I-Q characteristics at the predetermined rotation speed Np, the control circuitry 4 may calculate a converted flow rate by multiplying the minimum-use delivery flow rate Qmin by Np/Nr, and determine the minimum-use electric current 10 corresponding to the converted flow rate by using the actual measurement data.

In Embodiment 2, in a case where the actual measurement data is one indicating the predetermined rotation speed Np and the actual I-Q characteristics at the predetermined rotation speed Np, the control circuitry 4 may calculate the minimum-use delivery flow rate Qmin at the predetermined rotation speed Np by multiplying the minimum-use displacement q0 by the predetermined rotation speed Np, and determine the minimum-use electric current 10 corresponding to the minimum-use delivery flow rate Qmin by using the actual measurement data.

The determination of the minimum-use electric current 10 need not be performed by the control circuitry 4, but may be performed by the processor 65 of the mobile terminal 6 or 6A. Specifically, the processor 65 may determine the minimum-use electric current I0 corresponding to either the minimum-use delivery flow rate Qmin or the minimum-use displacement q0 by using the actual measurement data, and store the determined minimum-use electric current 10 in the memory 61. In this case, when the data transmission button 73 is tap-operated, the processor 65 may cause the wireless communicator 64 to transmit the actual measurement data and the minimum-use electric current 10, which are stored in the memory 61, to the wireless LAN router 5 or to the control circuitry 4.

Further, the processor 65 of the mobile terminal 6 or 6A need not display the virtual symbol reading button 72 on the touchscreen 62, but instead may start the camera 63 when the program icon displayed on the touchscreen 62 is tap-operated.

### SUMMARY

A first aspect of the present disclosure provides, as a first mode, a mobile terminal including a processor, a memory, a wireless communicator, a touchscreen, and a camera. The processor: obtains and stores actual measurement data in the memory when the camera has captured an image of a symbol displayed on a surface of a hydraulic pump whose displacement increases in accordance with increase in a command current, the actual measurement data indicating an actual relationship between the command current and the displacement of the hydraulic pump or indicating a predetermined rotation speed and an actual relationship between the command current and a delivery flow rate of the hydraulic pump at the predetermined rotation speed; displays, on the touchscreen, an input screen to input a minimum-use delivery flow rate of the hydraulic pump and a reference rotation speed of the hydraulic pump, the reference rotation speed being a rotation speed to define the minimum-use delivery flow rate, and stores, in the memory, the minimum-use delivery flow rate and the reference rotation speed that have been inputted with the input screen; and displays a virtual data transmission button on the touchscreen, and when the data transmission button is tap-operated, causes the wireless communicator to transmit the actual measurement data, the minimum-use delivery flow rate, and the reference rotation speed, which are stored in the memory, to control circuitry for the hydraulic pump or to a wireless LAN router connected to the control circuitry.

According to the above configuration, the control circuitry can determine a minimum-use electric current corresponding to the minimum-use delivery flow rate by using the actual measurement data. Therefore, with the control circuitry, the minimum-use delivery flow rate of the hydraulic pump at the reference rotation speed can be set precisely.

A second aspect of the present disclosure provides, as a second mode, a mobile terminal including a processor, a memory, a wireless communicator, a touchscreen, and a camera. The processor: obtains and stores actual measurement data in the memory when the camera has captured an image of a symbol displayed on a surface of a hydraulic pump whose displacement increases in accordance with increase in a command current, the actual measurement data indicating an actual relationship between the command current and the displacement of the hydraulic pump or indicating a predetermined rotation speed and an actual relationship between the command current and a delivery flow rate of the hydraulic pump at the predetermined rotation speed; displays, on the touchscreen, an input screen to input a minimum-use displacement of the hydraulic pump, and stores, in the memory, the minimum-use displacement that has been inputted with the input screen; and displays a virtual data transmission button on the touchscreen, and when the data transmission button is tap-operated, causes the wireless communicator to transmit the actual measurement data and the minimum-use displacement, which are stored in the memory, to control circuitry for the hydraulic pump or to a wireless LAN router connected to the control circuitry.

According to the above configuration, the control circuitry can determine a minimum-use electric current corresponding to the minimum-use displacement by using the actual measurement data. Therefore, with the control circuitry, the minimum-use displacement of the hydraulic pump can be set precisely.

A third aspect of the present disclosure provides, as a third mode, a mobile terminal including a processor, a memory, a wireless communicator, a touchscreen, and a camera. The processor: obtains and stores actual measurement data in the memory when the camera has captured an image of a symbol displayed on a surface of a hydraulic pump whose displacement increases in accordance with increase in a command current, the actual measurement data indicating an actual relationship between the command current and the displacement of the hydraulic pump or indicating a predetermined rotation speed and an actual relationship between the command current and a delivery flow rate of the hydraulic pump at the predetermined rotation speed; displays, on the touchscreen, an input screen to input a minimum-use delivery flow rate of the hydraulic pump and a reference rotation speed of the hydraulic pump, the reference rotation speed being a rotation speed to define the minimum-use delivery flow rate, stores, in the memory, the minimum-use delivery flow rate and the reference rotation speed that have been inputted with the input screen, determines a minimum-use electric current corresponding to the inputted minimum-use delivery flow rate by using the actual measurement data, and stores the determined minimum-use electric current in the memory; and displays a virtual data transmission button on the touchscreen, and when the data transmission button is tap-operated, causes the wireless communicator to transmit the actual measurement data and the minimum-use electric current, which are stored in the memory, to control circuitry for the hydraulic pump or to a wireless LAN router connected to the control circuitry.

According to the above configuration, the minimum-use electric current corresponding to the minimum-use delivery flow rate is determined by using the actual measurement data, and is transmitted to the control circuitry. Therefore, with the control circuitry, the minimum-use delivery flow rate of the hydraulic pump at the reference rotation speed can be set precisely.

A fourth aspect of the present disclosure provides, as a fourth mode, a mobile terminal including a processor, a memory, a wireless communicator, a touchscreen, and a camera. The processor: obtains and stores actual measurement data in the memory when the camera has captured an image of a symbol displayed on a surface of a hydraulic pump whose displacement increases in accordance with increase in a command current, the actual measurement data indicating an actual relationship between the command current and the displacement of the hydraulic pump or indicating a predetermined rotation speed and an actual relationship between the command current and a delivery flow rate of the hydraulic pump at the predetermined rotation speed; displays, on the touchscreen, an input screen to input a minimum-use displacement of the hydraulic pump, stores, in the memory, the minimum-use displacement that has been inputted with the input screen, determines a minimum-use electric current corresponding to the inputted minimum-use displacement by using the actual measurement data, and stores the determined minimum-use electric current in the memory; and displays a virtual data transmission button on the touchscreen, and when the data transmission button is tap-operated, causes the wireless communicator to transmit the actual measurement data and the minimum-use electric current, which are stored in the memory, to control circuitry for the hydraulic pump or to a wireless LAN router connected to the control circuitry.

According to the above configuration, the minimum-use electric current corresponding to the minimum-use displacement is determined by using the actual measurement data, and is transmitted to the control circuitry. Therefore, with the control circuitry, the minimum-use displacement of the hydraulic pump can be set precisely.

As a fifth mode, in any one of the first to fourth modes, for example, the symbol may store the actual measurement data, and the processor may obtain the actual measurement data stored in the symbol when the camera has captured the image of the symbol.

As a sixth mode, in any one of the first to fourth modes, for example, the symbol may store save location information on the actual measurement data, and the processor may obtain the actual measurement data via a network from a server specified by the save location information stored in the symbol when the camera has captured the image of the symbol.

As a seventh mode, in any one of the first to sixth modes, for example, the processor may display, on the touchscreen, a virtual symbol reading button to start reading the symbol, and start the camera when the symbol reading button is tap-operated.

What is claimed is:

1. A mobile terminal comprising a processor, a memory, a wireless communicator, a touchscreen, and a camera, wherein
the processor:
obtains and stores actual measurement data in the memory when the camera has captured an image of a symbol displayed on a surface of a hydraulic pump whose displacement increases in accordance with increase in a command current, the actual measurement data indicating an actual relationship between the command current and the displacement of the hydraulic pump or indicating a predetermined rotation speed and an actual relationship between the command current and a delivery flow rate of the hydraulic pump at the predetermined rotation speed;
displays, on the touchscreen, an input screen to input a minimum-use delivery flow rate of the hydraulic pump and a reference rotation speed of the hydraulic pump, the reference rotation speed being a rotation speed to define the minimum-use delivery flow rate, and stores, in the memory, the minimum-use delivery flow rate and the reference rotation speed that have been inputted with the input screen; and
displays a virtual data transmission button on the touchscreen, and when the data transmission button is tap-operated, causes the wireless communicator to transmit the actual measurement data, the minimum-use delivery flow rate, and the reference rotation speed, which are stored in the memory, to control circuitry for the hydraulic pump or to a wireless LAN router connected to the control circuitry.

2. A mobile terminal comprising a processor, a memory, a wireless communicator, a touchscreen, and a camera, wherein
the processor:
obtains and stores actual measurement data in the memory when the camera has captured an image of a symbol displayed on a surface of a hydraulic pump whose displacement increases in accordance with increase in a command current, the actual measurement data indicating an actual relationship between the command current and the displacement of the hydraulic pump or indicating a predetermined rotation speed and an actual relationship between the command current and a delivery flow rate of the hydraulic pump at the predetermined rotation speed;
displays, on the touchscreen, an input screen to input a minimum-use displacement of the hydraulic pump, and stores, in the memory, the minimum-use displacement that has been inputted with the input screen; and
displays a virtual data transmission button on the touchscreen, and when the data transmission button is tap-operated, causes the wireless communicator to transmit the actual measurement data and the minimum-use displacement, which are stored in the memory, to control circuitry for the hydraulic pump or to a wireless LAN router connected to the control circuitry.

3. A mobile terminal comprising a processor, a memory, a wireless communicator, a touchscreen, and a camera, wherein
the processor:
obtains and stores actual measurement data in the memory when the camera has captured an image of a symbol displayed on a surface of a hydraulic pump whose displacement increases in accordance with increase in a command current, the actual measurement data indicating an actual relationship between the command current and the displacement of the hydraulic pump or indicating a predetermined rotation speed and an actual relationship between the command current and a delivery flow rate of the hydraulic pump at the predetermined rotation speed;
displays, on the touchscreen, an input screen to input a minimum-use delivery flow rate of the hydraulic pump and a reference rotation speed of the hydraulic pump, the reference rotation speed being a rotation speed to define the minimum-use delivery flow rate, stores, in the memory, the minimum-use delivery flow rate and the reference rotation speed that have been inputted with the input screen, determines a minimum-use electric current corresponding to the inputted minimum-use delivery flow rate by using the actual measurement data, and stores the determined minimum-use electric current in the memory; and
displays a virtual data transmission button on the touchscreen, and when the data transmission button is tap-operated, causes the wireless communicator to transmit the actual measurement data and the minimum-use electric current, which are stored in the memory, to control circuitry for the hydraulic pump or to a wireless LAN router connected to the control circuitry.

4. A mobile terminal comprising a processor, a memory, a wireless communicator, a touchscreen, and a camera, wherein
the processor:
obtains and stores actual measurement data in the memory when the camera has captured an image of a symbol displayed on a surface of a hydraulic pump whose displacement increases in accordance with increase in a command current, the actual measurement data indicating an actual relationship between the command current and the displacement of the hydraulic pump or indicating a predetermined rotation speed and an actual relationship between the command current and a delivery flow rate of the hydraulic pump at the predetermined rotation speed;
displays, on the touchscreen, an input screen to input a minimum-use displacement of the hydraulic pump, stores, in the memory, the minimum-use displacement that has been inputted with the input screen, determines a minimum-use electric current corresponding to the inputted minimum-use displacement by using the actual measurement data, and stores the determined minimum-use electric current in the memory; and
displays a virtual data transmission button on the touchscreen, and when the data transmission button is tap-operated, causes the wireless communicator to transmit the actual measurement data and the minimum-use electric current, which are stored in the memory, to control circuitry for the hydraulic pump or to a wireless LAN router connected to the control circuitry.

5. The mobile terminal according to claim 1, wherein
the symbol stores the actual measurement data, and
the processor obtains the actual measurement data stored in the symbol when the camera has captured the image of the symbol.

6. The mobile terminal according to claim 2, wherein
the symbol stores the actual measurement data, and
the processor obtains the actual measurement data stored in the symbol when the camera has captured the image of the symbol.

7. The mobile terminal according to claim 3, wherein
the symbol stores the actual measurement data, and
the processor obtains the actual measurement data stored in the symbol when the camera has captured the image of the symbol.

8. The mobile terminal according to claim 4, wherein
the symbol stores the actual measurement data, and
the processor obtains the actual measurement data stored in the symbol when the camera has captured the image of the symbol.

9. The mobile terminal according to claim 1, wherein
the symbol stores save location information on the actual measurement data, and
the processor obtains the actual measurement data via a network from a server specified by the save location information stored in the symbol when the camera has captured the image of the symbol.

10. The mobile terminal according to claim 2, wherein
the symbol stores save location information on the actual measurement data, and
the processor obtains the actual measurement data via a network from a server specified by the save location information stored in the symbol when the camera has captured the image of the symbol.

11. The mobile terminal according to claim 3, wherein
the symbol stores save location information on the actual measurement data, and
the processor obtains the actual measurement data via a network from a server specified by the save location information stored in the symbol when the camera has captured the image of the symbol.

12. The mobile terminal according to claim 4, wherein
the symbol stores save location information on the actual measurement data, and
the processor obtains the actual measurement data via a network from a server specified by the save location information stored in the symbol when the camera has captured the image of the symbol.

13. The mobile terminal according to claim 1, wherein
the processor displays, on the touchscreen, a virtual symbol reading button to start reading the symbol, and starts the camera when the symbol reading button is tap-operated.

14. The mobile terminal according to claim 2, wherein
the processor displays, on the touchscreen, a virtual symbol reading button to start reading the symbol, and starts the camera when the symbol reading button is tap-operated.

15. The mobile terminal according to claim 3, wherein
the processor displays, on the touchscreen, a virtual symbol reading button to start reading the symbol, and starts the camera when the symbol reading button is tap-operated.

16. The mobile terminal according to claim 4, wherein
the processor displays, on the touchscreen, a virtual symbol reading button to start reading the symbol, and starts the camera when the symbol reading button is tap-operated.
